(19) United States
(12) Patent Application Publication
(10) Pub. No.: US 2026/0005426 A1
(43) Pub. Date: Jan. 1, 2026

(54) Single Antenna Subharmonic Tags

(71) Applicant: Northeastern University, Boston, MA (US)

(72) Inventors: Cristian CASSELLA, Boston, MA (US); Nicolas CASILLI, Kendall Park, NJ (US); Luca COLOMBO, Boston, MA (US)

(21) Appl. No.: 19/112,067

(22) PCT Filed: Oct. 26, 2023
(86) PCT No.: PCT/US2023/036016

§ 371 Date: Mar. 14, 2025

Related U.S. Application Data
(60) Provisional application No. 63/419,683, filed on Oct. 26, 2022.

(51) Int. Cl. H01Q 1/22; H01Q 1/24

(52) U.S. Cl. CPC H01Q 1/2225; H01Q 1/247

(57) ABSTRACT

Provided herein are methods and systems for subharmonic tags including a single antenna having a reactive input impedance and a set of lumped components coupled to the antenna, the lumped components having a frequency-dependent input impedance, wherein the frequency-dependent input impedance of the lumped components causes the coupled antenna and lumped components to resonate at both an input frequency of the subharmonic tag and at an output frequency of the subharmonic tag.

### CROSS REFERENCE TO RELATED APPLICATIONS

This application claims benefit under 35 U.S.C. § 119 (e) of U.S. Provisional Application No. 63/419,683 filed on 26 Oct. 2022, entitled “Single Antenna Subharmonic Tags,” the entirety of which is incorporated by reference herein.

### STATEMENT REGARDING FEDERALLY SPONSORED RESEARCH OR DEVELOPMENT

This invention was made with government support under Grant Number 1854573 awarded by the National Science Foundation. The government has certain rights in the invention.

### BACKGROUND

The development of new algorithms of cloud storage and cloud computing, the unprecedented growth of artificial intelligence (AI), the increasing ubiquity of the Internet of Things, and the increasing availability of the edge for real-time sensor processing have built the foundations of new distributed sensing networks relying on widespread deployments of passive, printable, and chip-less wireless sensor nodes (WSNs). Many applications for such distributing sensing networks are recently emerged or still emerging and would tremendously benefit from fine-grained sensing capabilities ensuring long reading distances. For instance, there is a considerable interest in developing localization strategies to improve the reliability of automated-guided vehicles, achieving long-range wireless sensing capabilities in harsh environments, assessing critical environmental and structural parameters with a fine-grained spatial resolution, and performing target acquisition of objects with extremely low radar cross sections. Unfortunately, the sensitivity and reading range of most commercially available passive, printable, and chip-less WSNs are heavily degraded by multipath, self-interference, and clutter, since their output and interrogation signals operate at the same frequency. Also, these WSNs suffer from unsustainable reductions of reading range and sensitivity when attempting miniaturization for the sake of higher spatial resolutions.

Recently, subharmonic tags (SubHTs) have been developed as a new class of WSNs able to address these critical limitations. These tags rely on the nonlinear dynamics of varactor-based passive circuits to transmit any sensed information at half of their interrogation frequency, mitigating performance degradations due to multipath, self-interference of the reader, and clutter affecting conventional passive WSNs.

To activate their frequency division mechanism, SubHTs rely on an internal subharmonic oscillation triggered when the received interrogation signal exhibits a power (Pᵢₙ) exceeding a certain threshold (Pₜₕ). Differently from harmonic tags (HTs), which leverage polynomial nonlinearities to generate backscattered signals at twice their interrogation frequency, SubHTs can address both continuous and threshold-sensing functionalities. Uniquely, SubHTs can also passively memorize the occurrence of violations in a parameter of interest without requiring any memory components. Even more, when assuming the same interrogation signal, the output frequency of HTs is four times higher than the corresponding output of SubHTs. Therefore, the output signal of HTs typically undergoes a 12 dB higher path-loss compared to that of SubHTs. This 12 dB difference leads to reading ranges (dₘₐₓ) of HTs that are inevitably lower than those achievable by SubHTs.

Yet, to satisfy the resonant conditions that minimize/maximize their Pₜₕ/dₘₐₓ value, all prior demonstrated SubHTs rely on 2-port networks featuring a set of lumped components and two separate antennas, one receiving the interrogation signal and the other transmitting the frequency divided output signal. However, using two antennas increases the size of the SubHTs, impacting their ability to be used for remote sensing in applications demanding high spatial resolutions. As it stands, there has been skepticism on the potential of using SubHTs as remote sensing devices due to the fact that all the previous prototypes required two antennas.

### SUMMARY

Described herein are the first single-antenna subharmonic tags (SubHTs) ever demonstrated. Thanks to their nonlinear dynamics and despite a small form-factor, these SubHTs can leverage the high quality factor of their electrically small antennas (ESA) to trigger the activation of a subharmonic output signal at very low received input power thresholds (Pₜₕ). For example, the single-varactor SubHT of FIGS. 7 and 8 activates at a Pₜₕ lower than ˜8 dBm. The two-varactor SubHT of FIGS. 1 and 2A, by leveraging advantageous nonlinear dynamics provided by the adoption of two nonlinear components (in this case, varactors) in its circuit, exhibits an exceptionally low-power threshold (Pₜₕ=−18 dBm). Such a low Pₜₕ value is achieved regardless of the extraordinarily small size of the SubHTs (the area of each is only 1.3 cm2), which has been built onto a 12.4×10.6×1.6 mm FR-4 printed circuit board (PCB) 175 and uses a ultrahigh-frequency (UHF) ESA occupying just 78 mm².

When using an effective isotropic radiated power (EIRP) at 890 MHz of +36 dBm for interrogation in an uncontrolled electromagnetic environment, the two-varactor SubHT generates a subharmonic response at 445 MHz detectable from more than 13 m away from its interrogating device. This read-range exceeds by more than three times the detectable distance of the single-varactor SubHT on an identical PCB 175, wherein the only difference is replacement of the second varactor by an equivalent linear capacitor with a nominal capacitance identical to the varactor's zero-bias capacitance.

Thus, the single-antenna SubHTs, and particularly the two-varactor SubHT, described herein can provide highly miniaturized passive tags able to address the needs of Internet of Things (IoT) and other applications demanding far-field fine-grained sensing in electromagnetic settings impacted by multipath and clutter, including, for example, distributed wireless sensor networks, target acquisition, tracking, remote sensing, navigation, localization, and other applications that demand a fine-grained monitoring of targeted parameters of interest.

In one aspect, a subharmonic tag is provided. The subharmonic tag includes a single antenna having a reactive input impedance. The subharmonic tag also includes a set of lumped components coupled to the antenna. The lumped components have a frequency-dependent input impedance, wherein the frequency-dependent input impedance of the lumped components causes the coupled antenna and lumped components to resonate at both an input frequency of the subharmonic tag and at an output frequency of the subharmonic tag.

In some embodiments, the single antenna is an electrically small antenna. In some embodiments, The single antenna includes one or more of a resonant antenna, a dipole, a monopole, a loop, a short dipole, a small loop, a planar square loop, a microstrip, a dielectrically loaded patch, an aperture antenna, or combinations thereof. In some embodiments, the subharmonic tag is formed on a substrate. In some embodiments, the substrate is flexible. In some embodiments, the substrate is a PCB. In some embodiments, the subharmonic tag is formed in an integrated chip. In some embodiments, the output frequency is half of the input frequency. In some embodiments, the output frequency is 445 MHz and the input frequency is 890 MHz.

In some embodiments, the lumped components form a one-port parametric frequency divider (PFD). In some embodiments, the lumped components forming the PFD include a capacitive component. In some embodiments, the lumped components forming the PFD include an inductive component coupled in series to the capacitive component. In some embodiments, the lumped components forming the PFD include an output component connected in parallel to an input component to form a frequency-dependent portion of the PFD, the frequency-dependent portion of the PFD coupled in series to the capacitive component and the inductive component. In some embodiments, the capacitive component includes one or more of a capacitor or a varactor. In some embodiments, the inductive component includes an inductor. In some embodiments, each of the input component and the output component includes one or more of a capacitor, a varactor, an inductor, a MEMS resonator, a crystal resonator, a ceramic resonator, an inductive sensor, a capacitive sensor, or combinations thereof. In some embodiments, the output component includes one or more of a capacitor or a varactor. In some embodiments, the input component includes an inductor. In some embodiments, the output component causes the coupled antenna and PFD to resonate at the output frequency of the subharmonic tag. In some embodiments, ghe input component causes the coupled antenna and PFD to resonate at the input frequency of the subharmonic tag.

In another aspect, a method for passive wireless communication is provided. The method includes providing a subharmonic tag. The subharmonic tag includes a single antenna having a reactive input impedance. The subharmonic tag also includes a set of lumped components coupled to the antenna, the lumped components having a frequency-dependent input impedance, wherein the frequency-dependent input impedance of the lumped components causes the coupled antenna and lumped components to resonate at both an input frequency of the subharmonic tag and at an output frequency of the subharmonic tag. The method also includes receiving, by the antenna of the subharmonic tag, an interrogation signal having the input frequency. The method also includes resonating, responsive to the interrogation signal, the antenna and the lumped components at the output frequency. The method also includes transmitting, responsive to the resonating of the antenna and the lumped components at the output frequency, an output signal from the antenna.

In some embodiments, the lumped components form a one-port parametric frequency divider (PFD). In some embodiments, the lumped components forming the PFD include a capacitive component. In some embodiments, the lumped components forming the PFD include an inductive component coupled in series to the capacitive component. In some embodiments, the lumped components forming the PFD include an output component connected in parallel to an input component to form a frequency-dependent portion of the PFD. In some embodiments, the frequency-dependent portion of the PFD is coupled in series to the capacitive component and the inductive component. In some embodiments, the output component causes the coupled antenna and PFD to resonate at the output frequency of the subharmonic tag. In some embodiments, the input component causes the coupled antenna and PFD to resonate at the input frequency of the subharmonic tag.

Additional features and aspects of the technology include the following:

1 A subharmonic tag comprising:
a single antenna having a reactive input impedance; and
a set of lumped components coupled to the antenna, the lumped components having a frequency-dependent input impedance, wherein the frequency-dependent input impedance of the lumped components causes the coupled antenna and lumped components to resonate at both an input frequency of the subharmonic tag and at an output frequency of the subharmonic tag.

2. The subharmonic tag of feature 1, wherein the single antenna is an electrically small antenna.

3 The subharmonic tag of any of features 1 or 2, wherein the single antenna includes one or more of a resonant antenna, a dipole, a monopole, a loop, a short dipole, a small loop, a planar square loop, a microstrip, a dielectrically loaded patch, an aperture antenna, or combinations thereof.

4. The subharmonic tag of any of features 1-3, wherein the subharmonic tag is formed on a substrate.

5. The subharmonic tag of feature 4, wherein the substrate is flexible.

6. The subharmonic tag of feature 5, wherein the substrate is a PCB.

7. The subharmonic tag of any of features 1-6, wherein the subharmonic tag is formed in an integrated chip.

8. The subharmonic tag of any of features 1-7, wherein the output frequency is half of the input frequency.

9. The subharmonic tag of any of features 1-8, wherein the output frequency is 445 MHz and the input frequency is 890 MHz.

10. The subharmonic tag of any of features 1-9, wherein the lumped components form a one-port parametric frequency divider (PFD).

11. The subharmonic tag of feature 10, wherein the lumped components forming the PFD further comprise:
a capacitive component;
an inductive component coupled in series to the capacitive component; and
an output component connected in parallel to an input component to form a frequency-dependent portion of the PFD, the frequency-dependent portion of the PFD coupled in series to the capacitive component and the inductive component.

12. The subharmonic tag of feature 11, wherein the capacitive component includes one or more of a capacitor or a varactor.

13. The subharmonic tag of any of features 11-12, wherein the inductive component includes an inductor.

14. The subharmonic tag of any of features 11-13, wherein each of the input component and the output component includes one or more of a capacitor, a varactor, an inductor, a MEMS resonator, a crystal resonator, a ceramic resonator, an inductive sensor, a capacitive sensor, or combinations thereof.

15. The subharmonic tag of feature 14, wherein the output component includes one or more of a capacitor or a varactor.

16. The subharmonic tag of any of features 14-15, wherein the input component includes an inductor.

17. The subharmonic tag of any of features 11-16, wherein the output component causes the coupled antenna and PFD to resonate at the output frequency of the subharmonic tag.

18. The subharmonic tag of any of features 11-17, wherein the input component causes the coupled antenna and PFD to resonate at the input frequency of the subharmonic tag.

19. A method for passive wireless communication comprising:
providing a passive subharmonic tag (subharmonic tag) comprising:
   a single antenna having a reactive input impedance, and
   a set of lumped components coupled to the antenna, the lumped components having a frequency-dependent input impedance, wherein the frequency-dependent input impedance of the lumped components causes the coupled antenna and lumped components to resonate at both an input frequency of the subharmonic tag and at an output frequency of the subharmonic tag.
receiving, by the antenna of the subharmonic tag, an interrogation signal having the input frequency;
resonating, responsive to the interrogation signal, the antenna and the lumped components at the output frequency; and
transmitting, responsive to the resonating of the antenna and the lumped components at the output frequency, an output signal from the antenna.

20. The method of feature 19, wherein the lumped components form a one-port parametric frequency divider (PFD), wherein the lumped components forming the PFD include a capacitive component, an inductive component coupled in series to the capacitive component, and an output component connected in parallel to an input component to form a frequency-dependent portion of the PFD, the frequency-dependent portion of the PFD coupled in series to the capacitive component and the inductive component.

21. The method of any of features 19-20, wherein the output component causes the coupled antenna and PFD to resonate at the output frequency of the subharmonic tag.

22. The method of any of features 19-21, wherein the input component causes the coupled antenna and PFD to resonate at the input frequency of the subharmonic tag.

### BRIEF DESCRIPTION OF THE DRAWINGS

FIG. 1 illustrates a schematic representation of a single-antenna subharmonic tag (SubHT) in accordance with various embodiments. The interrogation signal is received by an electrically small antenna (ESA) and a frequency divided output signal is transmitted by the same ESA. A set of lumped components ensures satisfaction of the resonant conditions leading to a minimization of threshold power (Pₜₕ) using just two meshes.

FIG. 2A illustrates an image of an experimental single-antenna SubHT showing soldered lumped components and feature sizes of traces, an ESA, and a total size of a PCB on which the SubHT was built. For the experimental SubHT, antenna width W_{Ant}=48 mil, overall tag length L_{Tag}=496 mil, overall tag width W_{Tag}=408 mil, and width of the traces W_{Tr}=24 mil. Specific model numbers for the lumped components used in building the experimental SubHT are: first varactor C_{Var1}: SMV1430-040LF (1.24 pF with tuning range=30%), first inductor LB: 0402DC-4N6XGR (4.6 nH), second varactor C_{Var2}: SMV1405-040LF (2.7 pF with tuning range=40%), and second inductor L_{T}: 0402DC-22NXGR (22 nH)

FIG. 2B illustrates front and back views of a bare PCB of the experimental single-antenna SubHT of FIG. 2A adjacent to a U.S. quarter dollar coin used as a reference for its size. In the experimental SubHT, length of the ground plane (L_{Gr})=340 mil, and width of the ground plane (W_{Gr})=240 mil.

FIG. 3A illustrates a graphical representation of simulated input impedance for the ESA of the experimental SubHT of FIG. 2A. As shown, the small antenna resistance indicates poor radiation performance. However, the relatively large inductive impedance contributes to increasing the overall quality factor of the single-antenna SubHT, consequently reducing Pₜₕ. Using finite element methods, the experimental ESA's input impedance values at input frequency (fᵢₙ) were determined as (1+j·160)Ω(R_{Ain} and jωL_{Ain}), wherein R_{Ain} and L_{Ain} are the resistance and inductance of the ESA at fᵢₙ. The experimental ESA's input impedance values at output frequency (fₒᵤₜ) were determined as (0.1+j·60)Ω(R_{Aout} and jωL_{Aout}), wherein R_{Aout} and L_{Aout} are the resistance and inductance of the ESA at fₒᵤₜ.

FIG. 3B illustrates a graphical representation of simulated return loss for the ESA of the experimental SubHT of FIG. 2A when frequency-dependent input impedance (Z_{P}) of the lumped components equals the conjugate of reactive input impedance (Z_{A}) of the ESA at the interrogation frequency.

FIG. 3C illustrates a simulated radiation pattern at 890 MHz for the ESA of the experimental SubHT of FIG. 2A.

FIG. 4 illustrates FEM-simulated optimal Pₜₕ and maximum distance of detection (dₘₐₓ) trends versus SubHT area for the SubHT of FIGS. 1 and 2A using a power auxiliary generator (pAG) technique.

FIG. 5A illustrates a schematic view of a wireless setup used during testing of the experimental SubHT of FIG. 2A. This includes a signal generator delivering the interrogation signal at fᵢₙ, a power amplifier, a transmitting antenna, a receiving antenna, a second power amplifier, and a spectrum analyzer used as receiver. The wireless testing setup was configured emulates a conventional IoT-reader. As such, the antennas and measurement tools were placed in very close proximity to one another.

FIG. 5B illustrates a photographic image of the wireless setup of FIG. 5A.

FIG. 6A illustrates measured results for dₘₐₓ of the experimental SubHT of FIG. 2A compared to measured results for dₘₐₓ of the experimental SubHT of FIG. 8. Both experimental SubHT's were constructed on identical PCBs using the same embedding network. The only difference between the two designs is the adoption of an equivalent nonlinear capacitive element in the two-varactor SubHT of FIG. 2A instead of the linear capacitor used in the one-varactor SubHT of FIG. 8. As shown, the use of two varactors produces a more than three-fold increase (from 4.2 m to 13 m) in dₘₐₓ.

FIG. 6B illustrates measured results for Pₜₕ of the experimental SubHT of FIG. 2A compared to measured results for Pₜₕ of the experimental SubHT of FIG. 8. As shown, the use of a single varactor instead of two degrades the performance of the system by more than 10 dB.

FIG. 6C illustrates measured dₘₐₓ and Pₜₕ values for the experimental SubHT of FIG. 2A.

FIG. 7 illustrates a schematic representation of an alternative single-antenna subharmonic tag (SubHT) having a single varactor in accordance with various embodiments.

FIG. 8 illustrates an image of an alternative experimental single-antenna SubHT having a single varactor and a linear capacitor, showing soldered lumped components and feature sizes of traces, an ESA, and a total size of a PCB on which the single-varactor SubHT was built. For the single-varactor SubHT, antenna width W_{Ant}=48 mil, overall tage length L_{Tag}=496 mil, overall tag width W_{Tag}=408 mil, and width of the traces W_{Tr}=24 mil. Specific model numbers for the lumped components used in building the experimental SubHT are varactor SMV1430-040LF (1.24 pF with tuning range=30%), first inductor 0402DC-4N6XGR (4.6 nH), linear capacitor GRM1555C1E2R6CA01 (2.6 pF), and second inductor L_{T} 0402DC-22NXGR (22 nH).

FIG. 9A illustrates a schematic view of a wireless setup used during testing of the experimental single-varactor SubHT of FIG. 8. This includes a signal generator delivering the interrogation signal at fᵢₙ, a power amplifier, a transmitting antenna, a receiving antenna, and a spectrum analyzer used as receiver. The wireless testing setup was configured to emulate a conventional IoT-reader. As such, the antennas and measurement tools were placed in very close proximity to one another.

FIG. 9B illustrates a photographic image of the wireless setup of FIG. 9A.

FIG. 10 illustrates measured and simulated Pₜₕ and dₘₐₓ trends for the experimental single-varactor SubHT of FIGS. 7 and 8 across a range of fᵢₙ values centered around a targeted value of 916 MHz. The simulated curves were both extracted using a power auxiliary generator (pAG) technique.

FIG. 11 illustrates a comparison on a logarithmic-scale between the experimental single-varactor SubHT of FIG. 8 and prior art tags in terms of their FoM value (see Eq. 1) and of the interrogation frequency employed during the characterization of each such tag.

### DETAILED DESCRIPTION

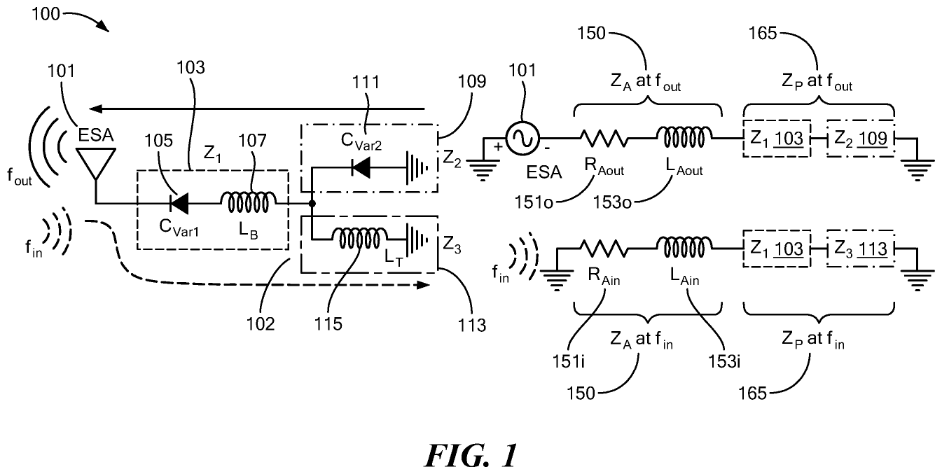

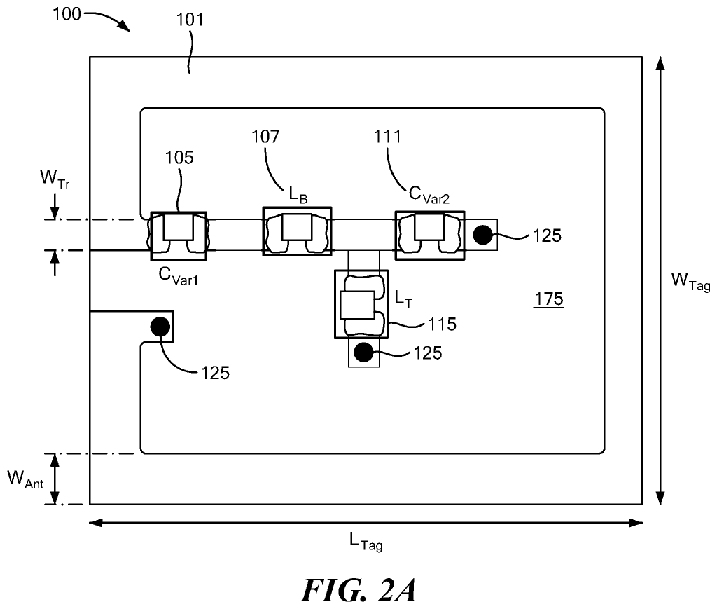

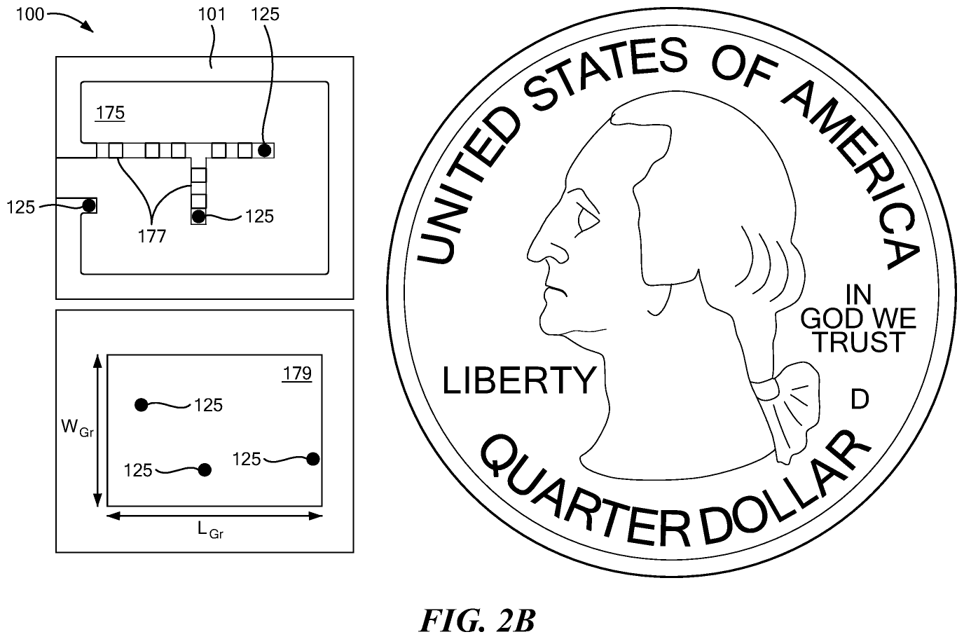

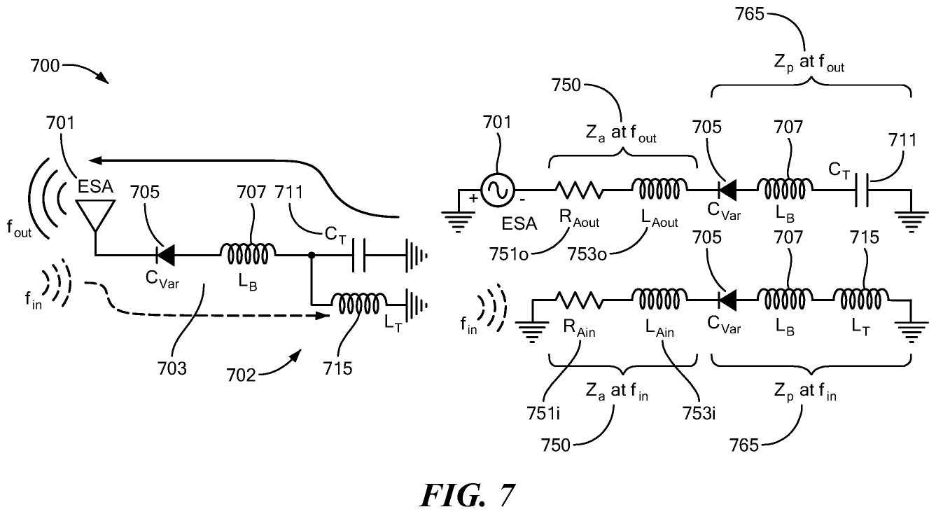

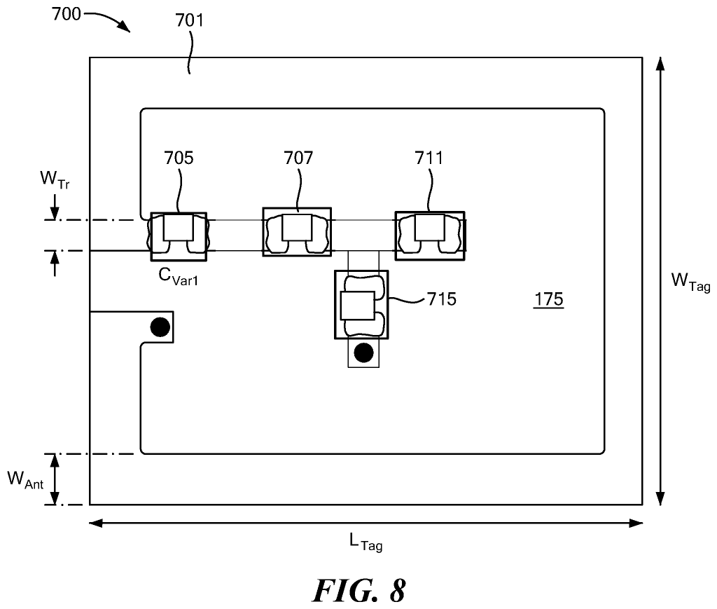

Provided herein are the first SubHTs embodying a single electrically small antenna (ESA) for both receiving the interrogation frequency (fᵢₙ) and transmitting the output frequency (fₒᵤₜ) (see FIGS. 1 and 7). Such SubHTs include a new parametric circuit topology that minimizes Pₜₕ without requiring two separate antennas. Despite the relatively low gain of ESAs, which, in the experimental prototypes described herein, have a maximum dimension of ˜λᵢₙ/12 (where λᵢₙ is the electromagnetic wavelength at fᵢₙ for the adopted antenna substrate), the described single-antenna SubHTs achieve very low received input power thresholds (Pₜₕ). For example, the single-varactor SubHT of FIGS. 7 and 8 activates at a Pₜₕ lower than ˜8 dBm. The two-varactor SubHT of FIGS. 1 and 2A, by leveraging advantageous nonlinear dynamics provided by the adoption of two nonlinear components (in this case, varactors) in its circuit, exhibits an even smaller low-power threshold (Pₜₕ=−18 dBm). Such a low Pₜₕ value is achieved regardless of the extraordinarily small size of the SubHTs (the area of each is only 1.3 cm2), which has been built onto a 12.4×10.6×1.6 mm³ FR-4 printed circuit board (PCB) and uses a ultrahigh-frequency (UHF) ESA occupying just 78 mm².

Such low thresholds are enabled by the unique dynamics of the SubHT, which make the threshold power for the activation of any parametric oscillations inversely proportional to the total losses in the SubHTs' circuits. Thanks to this property, in fact, the present SubHTs using electrically small antennas (ESAs) can even exhibit lower Pₜₕ values than counterparts using larger (e.g., lower quality factor) antennas. This allows partial compensation for any antenna gain reduction due to miniaturization of the SubHT, enabling long reading ranges despite relying on ESAs.

### I. Single-Antenna, Two-Varactor Subharmonic Tag

### Design and Analysis

Referring now to FIG. 1, a single-antenna SubHT 100 can be formed on or in any suitable substrate 175. For example, as shown in FIGS. 2A and 2B, the substrate 175 can be a rigid PCB 175 having a ground plane 179 and one or more traces 177 and ground vias 125 formed therein. However, it will be apparent in view of this disclosure that any suitable electronic substrate can be used in accordance with various embodiments. For example, the substrate 175 can include one or more of PCBs, flexible PCBs, flexible substrates, integrated circuits, MEMS circuits, or any other suitable medium for supporting and/or incorporating electronic and conductive components.

The single-antenna Sub-HT can include an antenna 101 (e.g., an ESA as shown) having a reactive input impedance (Z_{A}) 150 comprising both a resistive characteristic 151i, 1510 and an inductive characteristic 153i, 1530 of the antenna 101 at a given frequency. The antenna 101 is coupled to a set of lumped components 102 (e.g., a one-port PFD as shown) having a frequency-dependent input impedance (Z_{P}) 165. In use, Z_{P} 165 of the lumped components 102 resonates with the Z_{A} 150 of the antenna 101 at both an interrogation/input frequency (fᵢₙ) of the subharmonic tag and at an output frequency (fₒᵤₜ) of the subharmonic tag 100.

The antenna 101, although shown and described herein as being an ESA planar square loop antenna, can, in some embodiments, be any suitable resonant antenna, including, for example, one or more of a resonant antenna, a dipole, a monopole, a loop, a short dipole, a small loop, a planar square loop, a microstrip, a dielectrically loaded patch, an aperture antenna, or combinations thereof.

In some embodiments, as shown in FIG. 1, the lumped components 102 are configured to form a one-port parametric frequency divider (PFD). The lumped components 102 generally include a series circuit (Z1) 103 connected in series with a frequency-dependent portion having an output circuit (Z2) 109 connected in parallel to an input circuit (Z3) 113.

The series circuit 103 includes a capacitive component (e.g., series varactor (C_{Var1}) 105 as shown), and an inductive component 107 (e.g., series inductor (LB) 107 as shown), coupled in series to the capacitive component.

The input component 113 and output component 109 are connected in parallel to form the frequency-dependent portion of the lumped components 102 and can be any suitable circuitry for causing the single-antenna SubHT 100 to resonate at fᵢₙ and fₒᵤₜ, respectively. Such components can include, for example, one or more of a capacitor, a varactor, an inductor, a MEMS resonator, a crystal resonator, a ceramic resonator, an inductive sensor, a capacitive sensor, combinations thereof, or any other suitable circuit components. As shown in FIGS. 1 and 2A, the output component 109 is a second varactor (C_{Var2}) 111 and the output component 113 is a second inductor (L_{T}) 115.

In existing two-port SubHTs topologies, the satisfaction of four resonance-conditions is required to minimize Pₜₕ. Single-antenna SubHTs rely instead on the satisfaction of only three conditions. In particular, to generate the lowest possible Pₜₕ, it is critical to make the series of Z_{A} and Z_{P} resonate at both fᵢₙ and fₒᵤₜ. Although SubHTs are not limited to any particular relationship between fᵢₙ and fₒᵤₜ, typically SubHT are designed such that fₒᵤₜ=fᵢₙ/2. For example, the single-antenna, two-varactor SubHT tag shown and described in FIGS. 1 and 2A-2B is designed to operate with an interrogation frequency (fᵢₙ) of 890 MHz and an output frequency (fₒᵤₜ) of 445 MHz. As described below, the single-varactor design shown and described in connection with FIGS. 7 and 8 is designed to operate with an interrogation frequency (fᵢₙ) of 916 MHz and an output frequency (fₒᵤₜ) of 458 MHz.

The third condition involves maximizing the voltage swing across the nonlinear elements to generate a large parametric modulation of the impedance in the circuit. In this regard, having two nonlinear capacitors (e.g., varactors 105, 111) increases the effective impedance modulation in the circuit for any received power level, greatly reducing the Pₜₕ required to activate the frequency division. To satisfy the three resonance conditions for the single-antenna, two-varactor SubHT described herein, L_{T} and C_{Var2} were chosen to produce, together with C_{Var1} and LB, a series resonance at both fᵢₙ and fₒᵤₜ (FIG. 1). Hyperabrupt varactors were used to maximize the achievable capacitive tuning range.

The employed ESA shown in FIGS. 1 and 2A-2B is of a planar square loop antenna built on an FR-4 substrate 175 with a circumference of 0.12·λᵢₙ, where λᵢₙ is the electromagnetic wavelength of the interrogation frequency in the substrate 175. This antenna structure inherently exhibits a reactive input impedance with a relatively low dependence of its equivalent inductance against frequency. The selection of a loop antenna reduces the single-antenna SubHT's overhead area as the components required to synthesize Z_{P} can be placed within the loop's perimeter without substantially perturbing the radiation characteristics of the antenna. Front-and back-view pictures of the built single-antenna SubHT, including the ESA and the layout of the soldered components are shown in FIGS. 2A and 2B. The designed ESA's input impedance 150 values at fᵢₙ were determined as (1+j·160)Ω(R_{Ain} and jωL_{Ain}), wherein R_{Ain} 151i and L_{Ain} 153i are the resistance and inductance of the ESA at fᵢₙ. The experimental ESA's input impedance values 150 at output frequency fₒᵤₜ were determined as (0.1+j·60) @ (R_{Aout} and jωL_{Aout}), wherein R_{Aout} 1510 and L_{Aout} 1530 are the resistance and inductance of the ESA 101 at fₒᵤₜ.

Such a low resistance forming Z_{A} is a clear indication of the ESA's suboptimal radiation efficiency, as expected based on its small form-factor. All things considered, using low radiation resistance antennas (e.g., antennas with a high radiation quality factor) in SubHTs reduces the losses that the parametric gain generated from the capacitance modulation of the adopted varactors must compensate to trigger the subharmonic oscillation. For this reason, using an ESA in single-antenna SubHTs enables a partial compensation of single-antenna

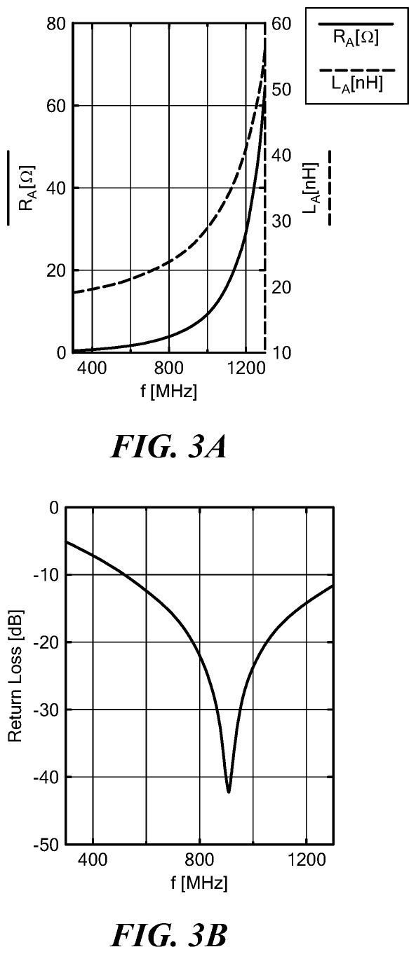

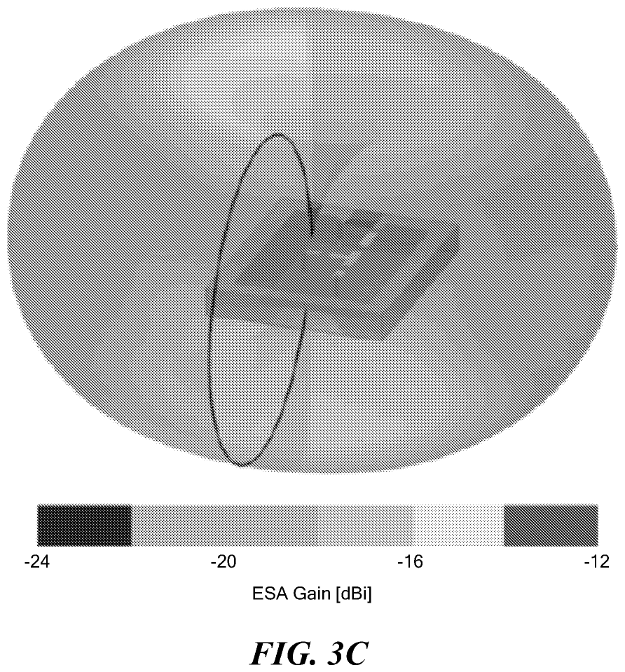

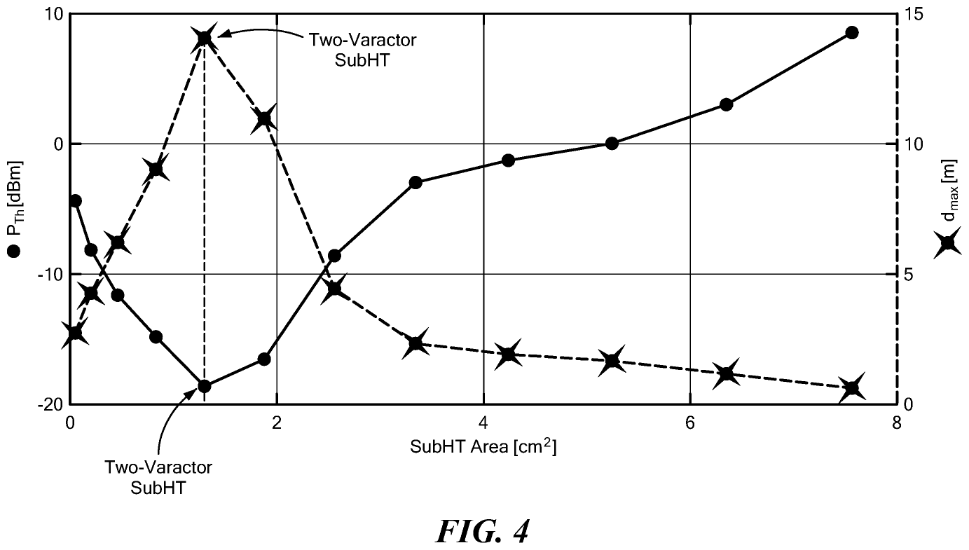

SubHTs' reduced antenna gain due to miniaturization. The gain of the antenna used by the single-antenna, two-varactor SubHT 100 was found to be −12.5 dBi at fᵢₙ and −15.4 dBi at fₒᵤₜ through FE analysis. As anticipated for a miniaturized loop antenna, the radiation characteristics conform to a two-lobe structure with its maxima located in the plane of the printed loop. The same FE methods have also confirmed that only the single-antenna SubHT's portion not covered by the bottom grounded plate contributed to radiation. This feature allows quantification of the area of the radiating portion of the single-antenna SubHT as 78 mm². The antenna circuit parameters and radiation pattern of the ESA can be found in FIGS. 3A-3C. The estimations of the input impedances and intrinsic gain levels permitted use of the power auxiliary generator (pAG) technique to predict Pₜₕ and calculate the maximum distance of detection (dₘₐₓ) for the simulated and designed single-antenna SubHT. Using this pAG method also enabled design compensation for any degradations of Pₜₕ due to layout parasitics and undesired deviations in component values compared to the nominal ones. This technique was also used to simulate optimal performance of the SubHT (see FIG. 4) when scaling its area (hence the area of its ESA) while maintaining the same circuit topology and quality factor for all the adopted lumped components. As shown, making the SubHT's area smaller or larger than what was used generates significant degradations of maximum distance of detection (dₘₐₓ) and Pₜₕ. In other words, the designed SubHT exhibits an ideal size when targeting a large dₘₐₓ value and the smallest possible SubHT's area.

### Experimental Setup and Results

Referring now to FIGS. 2A and 2B, in order to test the two-varactor SubHT, an experimental prototype was built onto a 12.4×10.6×1.6 mm FR-4 printed circuit board (PCB) by soldering off-the-shelf lumped components 102. For the experimental two-varactor SubHT, antenna width (W_{Ant})=48 mil, overall tag length (L_{Tag})=496 mil, overall tag width (W_{Tag})=408 mil, and width of traces 177 (W_{Tr})=24 mil. Specific model numbers for the lumped components used in building the experimental SubHT are: first varactor C_{Var1}: SMV1430-040LF (1.24 pF with tuning range=30%), first inductor LB: 0402DC-4N6XGR (4.6 nH), second varactor C_{Var2}: SMV1405-040LF (2.7 pF with tuning range=40%), and second inductor L_{T}: 0402DC-22NXGR (22 nH). The length of the ground plane 179 (L_{Gr})=340 mil, and width of the ground plane 179 (W Gr)=240 mil.

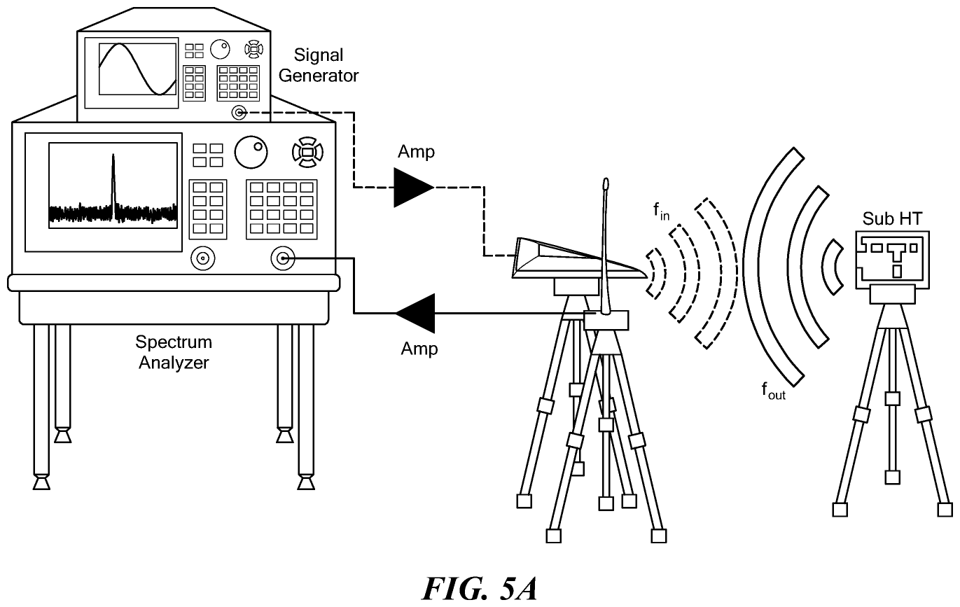

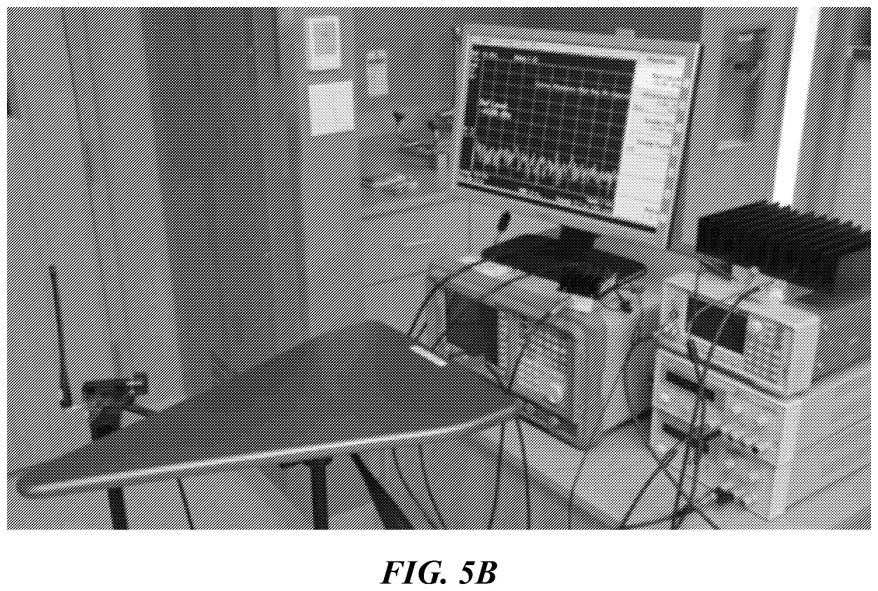

To characterize the performance of the SubHTs, a wireless setup was assembled, operating in a shared laboratory. Such a setup permitted emulation of an IoT reader capable of transmitting an effective isotropic radiated power (EIRP) of +36 dBm at the interrogation frequency while showing an RF sensitivity of −115 dBm at the output frequency. The experimental setup included: 1) a signal generator (model-number: Tektronix TSG 4104A) transmitting-4 dBm and connected to a commercial ultra-wideband antenna (Aaronia HyperLOG 4025, with a gain of +4 dBi) through a power amplifier (model-number: ZHL-1000-3 W+) and 2) a spectrum analyzer (model-number: Agilent ESA-E4402B) with input port connected to a power amplifier (model-number: ZHL-72A+) used to boost the sensitivity of the receiver from −95 to −115 dBm. This amplifier is connected to a 450 MHz half-wavelength dipole antenna (model-number: 712-ANT-433-CW-QW, with a gain of +3.3 dBi) placed in close vicinity to the other antenna. A schematic overview of the adopted setup, as well as a photo of the experimental setup, is provided in FIGS. 5A and 5B. To assess Pₜₕ, the single-antenna SubHT was placed onto a plastic tripod aligned with the direction of maximum gain of the transmitting antenna connected to the signal generator. The tripod was then progressively moved away from the wireless setup until a measurable response at fₒᵤₜ was no longer detected by the spectrum analyzer. The distance immediately prior to this lack of detection was recorded as the dₘₐₓ value. To extract Pₜₕ, received power of the single-antenna SubHT at fᵢₙ was estimated using the Friis free-space propagation model, for a distance from the signal generator equal to dₘₐₓ.

The same analysis was repeated for several frequencies in the neighborhood of the targeted operational frequency of the single-antenna SubHT. As expected, the single-antenna SubHT shows the longest dₘₐₓ and the lowest Pₜₕ at the designed frequency of 890 MHz. The dₘₐₓ of the constructed device was 13.5 m, corresponding to a Pₜₕ value of −18 dBm. Table I compares the reading range and total area of the measured single-antenna SubHT to current state-of-the-art passive, chipless and batteryless counterparts.

TABLE I
COMPARISON TABLE SHOWING THE PERFORMANCE
OF VARIOUS PASSIVE SENSING TAGS SPANNING
SEVERAL FREQUENCY RANGES

| Device | fᵢₙ | | λ | dₘₐₓ | | Area | EIRP |
|---|---|---|---|---|---|---|---|
| This Work | 890 | MHz | 0.34 m | 13.5 | m | 0.001λ² | +36 dBm |
| [3] (SubHT) | 870 | MHz | 0.35 m | 4 | m | 0.078λ² | +26 dBm |
| [10] (SubHT) | 886 | MHz | 0.38 m | 4.5 | m | 0.066λ² | +37 dBm |
| [12] (SubHT) | 790 | MHz | 0.34 m | 4 | m | 0.082λ² | +36 dBm |
| [13] | 915 | MHz | 0.33 m | 0.4 | m | 0.012λ² | +30 dBm |
| [14] | 1.59 | GHz | 0.19 m | 1.5 | m | 1.197λ² | +10 dBm |
| [15] | 6.5 | GHz | 0.05 m | 1.4 | m | 0.080λ² | +30 dBm |
| [16] | 2.5 | GHz | 0,12 m | 0,5 | m | 0.056λ² | +12 dBm |
| [17] | 1.04 | GHz | 0.29 m | 1.0 | m | 0.004λ² | +15 dBm |

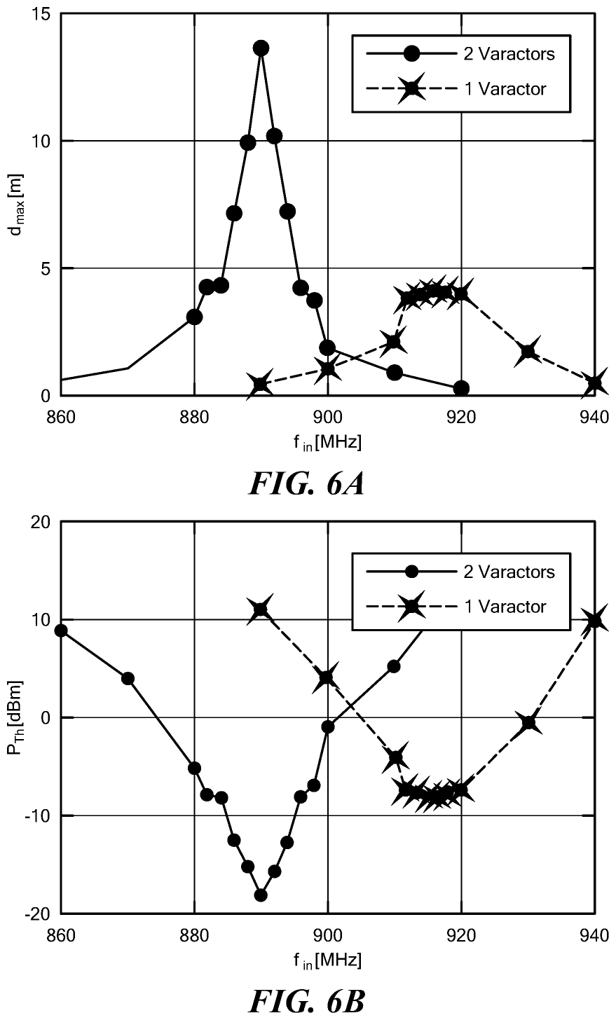

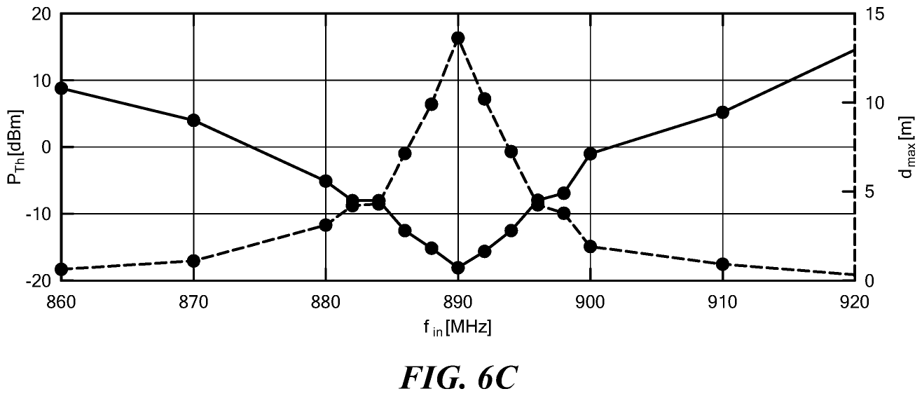

To validate the design, it was decided to include two nonlinear components (varactors as shown and described herein) to most efficiently modulate the reactance in the circuit. In addition, another single-antenna SubHT was built on an identical PCB wherein, as described below, the second varactor C_{Var2} was replaced with a capacitor (Cr) exhibiting the same capacitance as the removed unbiased varactor for small signals. The same wireless characterization procedure used to characterize the performance of the two-varactor SubHT was also used to assess the Pₜₕ and dₘₐₓ values of the single-varactor SubHT. It was found that, in addition to shifting the optimal interrogation frequency upward by almost 30 MHZ, the Pₜₕ of the single-varactor device was degraded by more than 10 dB, leading to reading ranges reduced by a factor of more than three (see FIGS. 6A-6C). This result shows that the inclusion of a second nonlinear component in the parametric circuit is critical for ensuring a minimized Pₜₕ and maximized dₘₐₓ.

When accounting for the miniaturized size of the single-antenna, two-varactor SubHT, the dₘₐₓ value demonstrated herein enables the development of passive tags for a variety of applications, including distributed wireless sensor networks for Internet of Things, target acquisition, tracking, remote sensing, navigation, localization, and other applications that demand a fine-grained monitoring of targeted parameters of interest.

### II. Single-Varactor, Single-Antenna Subharmonic Tag

### Design and Analysis

Referring now to FIG. 7, a single-antenna, single-varactor SubHT 700 can include an antenna 701 (e.g., an ESA as shown) having a reactive input impedance (Z_{A}) 750 comprising both a resistive characteristic 751i, 7510 and an inductive characteristic 753i, 7530 of the antenna 701 at a given frequency. The antenna 701 is coupled to a set of lumped components 702 (e.g., a one-port PFD as shown) having a frequency-dependent input impedance (Z_{P}) 765. In use, Z_{P} 765 of the lumped components 702 resonates with the Z_{A} 750 of the antenna 701 at both an interrogation/input frequency (fᵢₙ) of the subharmonic tag and at an output frequency (fₒᵤₜ) of the subharmonic tag 700.

In some embodiments, as shown in FIG. 1, the lumped components 702 are configured to form a one-port parametric frequency divider (PFD). The lumped components 702 generally include a series circuit 703 connected in series with a frequency-dependent portion having an output circuit 709 connected in parallel to an input circuit 713.

The series circuit 703 includes a capacitive component (e.g., series varactor (C_{Var1}) 705 as shown), and an inductive component 707 (e.g., series inductor (LB) 707 as shown), coupled in series to the capacitive component.

The input component 713 and output component 709 are connected in parallel to form the frequency-dependent portion of the lumped components 702 and can be any suitable circuitry for causing the single-antenna SubHT 700 to resonate at fᵢₙ and fₒᵤₜ, respectively. Such components can include, for example, one or more of a capacitor, a varactor, an inductor, a MEMS resonator, a crystal resonator, a ceramic resonator, an inductive sensor, a capacitive sensor, combinations thereof, or any other suitable circuit components. As shown in FIGS. 7 and 8, the output component 709 for the single-varactor SubHT 700 is a linear capacitor (CT) 711 and the output component 713 is a second inductor (L_{T}) 715.

As noted above, single-antenna SubHTs rely on the satisfaction of only three conditions. The first and second are that, to generate the lowest possible Pₜₕ, it is critical to make the series of Z_{A} and Z_{P} resonate at both fᵢₙ and fₒᵤₜ. Although SubHTs are not limited to any particular relationship between fᵢₙ and fₒᵤₜ, typically SubHT are designed such that fₒᵤₜ=fᵢₙ/2. For example, as described above, the single-antenna, two-varactor SubHT tag shown and described in FIGS. 1 and 2A-2B is designed to operate with an interrogation frequency (fᵢₙ) of 890 MHZ and an output frequency (fₒᵤₜ) of 445 MHz. The single-varactor design shown and described here in connection with FIGS. 7 and 8 is designed to operate with an interrogation frequency (fᵢₙ) of 916 MHz and an output frequency (fₒᵤₜ) of 458 MHz.

As further noted above, the third condition involves maximizing the voltage swing across the nonlinear elements to generate a large parametric modulation of the impedance in the circuit. In this regard, having only the single varactor 705 decreases the effective impedance modulation in the circuit for the single-varactor SubHT, increasing the Pₜₕ required to activate the frequency division. To satisfy the three resonance conditions for the single-antenna, single-varactor SubHT described herein, L_{T} 715 and CT 711 were chosen to produce, together with C_{Var} 705 and LB 707, a series resonance at both fᵢₙ and fₒᵤₜ (FIG. 1). A hyperabrupt varactor was used to maximize the achievable capacitive tuning range. However, it will be understood in view of this disclosure that any varactor or other nonlinear circuit component can be used.

The capacitor CT 711 was chosen to resonate with LB 707, C_{Var} 705, and Zₐ at fₒᵤₜ, whereas L_{T} 715 was selected to resonate with LB 707, C_{Var} 705, and Zₐ at fᵢₙ. This selected topology satisfies the first two design conditions while the adoption of a low capacitance varactor boosts the voltage magnitude at fᵢₙ across C_{Var} 705, which is also crucial to lower the power required to trigger the parametric generation of the SubHT's output signal (FIG. 7). With regards to the ESA employed by the present SubHT, a planar square loop antenna was built on a FR-4 substrate, with a circumference of 0.12·λᵢₙ. Such an ESA 701 inherently exhibits a reactive input impedance with a relatively low dependence of its equivalent inductance vs. frequency. Also, the selection of a loop antenna helps reduce the overhead area of the SubHT, as the required lumped components for the parametric circuit can be placed within the loop's perimeter without significantly perturbing the ESA's radiation characteristics and intrinsic gain. A front-view picture of the built SubHT, including the ESA and the layout used for soldering its components, is shown in FIG. 8. The designed ESA's input impedance values at fᵢₙ and fₒᵤₜ were estimated through finite-element (FE) methods as (6+j151)Ω(R_{Ain} and L_{Ain}) and (1+j57)Ω(R_{Aout} and L_{Aout}), respectively. Such low resistance values are clear indications of a sub-optimal radiation efficiency, as expected from the ESA's miniaturized form-factor. Nevertheless, using low-resistance (e.g., high quality factor) antennas in SubHTs reduces the losses that the parametric gain generated from the capacitance modulation of their varactor must compensate to trigger the subharmonic oscillation. This property, demonstrated for the first time herein, preserves low Pₜₕ values despite using a miniaturized antenna with low intrinsic gains. In this regard, the gain levels of the present ESA 101 for the single-varactor SubHT 700 at fᵢₙ and fₒᵤₜ were found through FE-simulations to be −4 dBi and −3.6 dBi, respectively. Also, the identification of the ESA's input impedance and intrinsic gain-levels allowed use of the Power Auxiliary Generator (pAG) technique to predict Pₜₕ and, consequently, the maximum achievable dₘₐₓ value. Using the pAG-technique also enabled a design compensation for any Pₜₕ-degradations due to layout parasitics and to undesired changes of the selected lumped components with respect to their nominal value.

### Experimental Setup and Results

Referring now to FIGS. 8 and 2B, the single-varactor SubHT 700 was built on the same 12.4 mm×10.6 mm×1.6 mm FR-4 printed circuit board (PCB) 175 having the same traces 177 and ground plane 179 as the PCB 175 used for the two-varactor SubHT 100. To characterize the performance of the built single-varactor SubHT 700, a wireless set-up was assembled. This set-up was used to emulate an IoT reader able to transmit an Equivalent

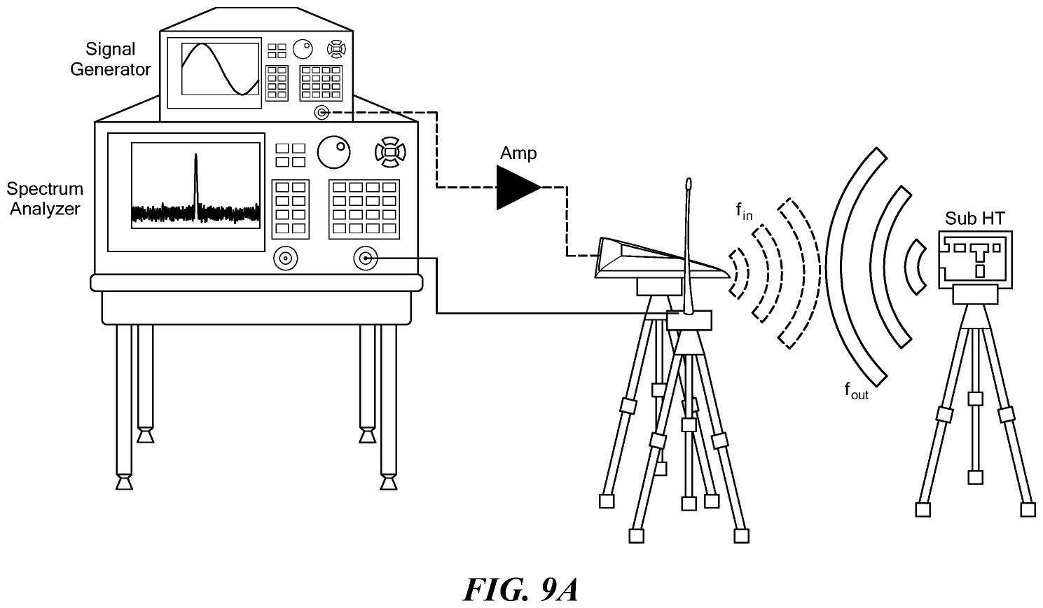

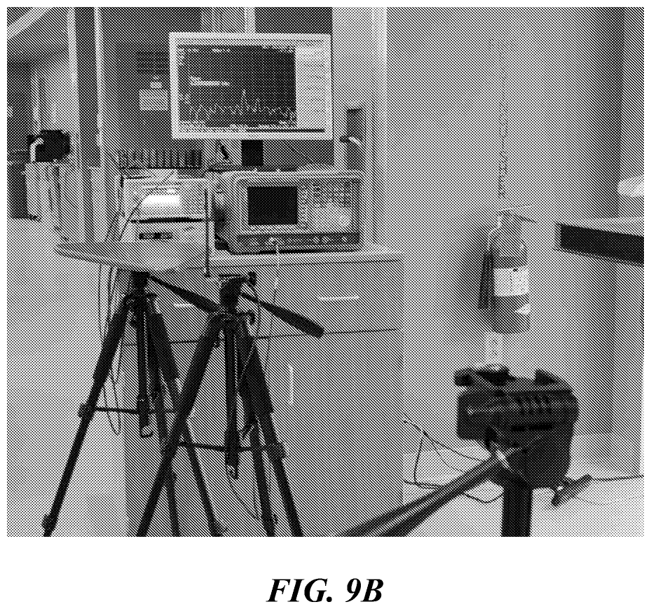

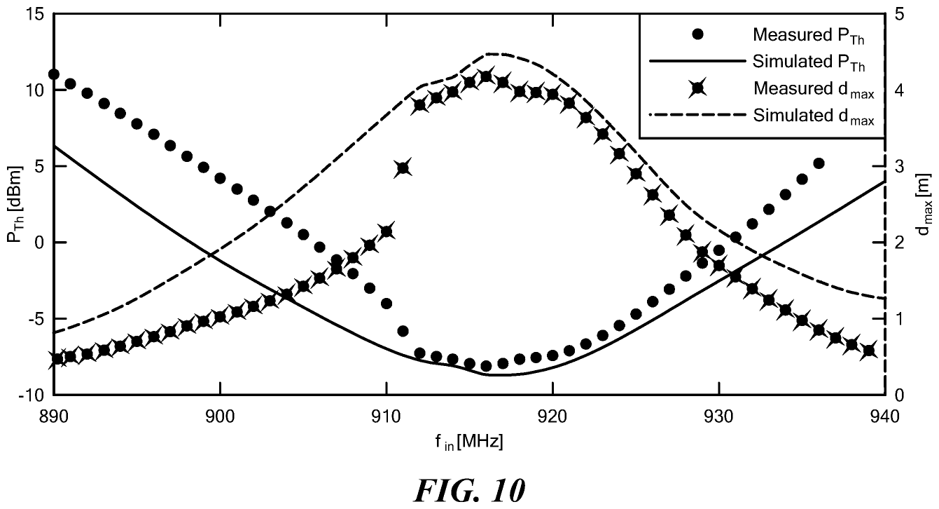

Isotropic Radiated Power (EIRP) of +36 dBm at 916 MHz and showing an RF sensitivity of −95 dBm at 458 MHz. The set-up was formed by: i) a signal generator (model-number Tektronix TSG 4104A) transmitting-4 dBm and connected to a commercial ultra-wideband antenna (Aaronia HyperLOG 4025, with a gain of +4 dBi) through a power amplifier (model-number: ZHL-1000-3 W+) and ii) a spectrum analyzer (model-number: Agilent ESA-E4402B) with input port connected to a 450 MHz half-wavelength dipole antenna (model number: 712-ANT-433-CW-QW, with a gain of +3.3 dBi) placed in close vicinity to the signal generator. The amplifier was used to boost the total radiated power level at fᵢₙ up to +32 dBm. A schematic overview of the adopted set-up, as well as a photo of the experimental setup, is shown in FIGS. 9A and 9B. In order to assess Pₜₕ and dₘₐₓ, the single-varactor SubHT was placed onto a plastic tripod, aligned with the direction of maximum gain of the antenna connected to the signal generator. The tripod was then progressively moved away from wireless set-up until a measurable response at fₒᵤₜ was no longer detected by the spectrum analyzer. The distance immediately prior to this lack of detection was recorded as the dₘₐₓ value. In order to extract Pₜₕ, the SubHT's received power was estimated at fᵢₙ, for a distance from the signal generator equal to dₘₐₓ, using the Friis free-space propagation model. The same analysis was repeated for several frequencies close to the targeted fᵢₙ value to determine the trends of dₘₐₓ and Pₜₕ vs. fᵢₙ (FIG. 10). The built SubHT showed the longest dₘₐₓ value and the lowest Pₜₕ (−8 dBm) at 916 MHz. Moreover, the extracted dₘₐₓ and Pₜₕ trends vs. fᵢₙ closely matched the corresponding predicted trends found through circuit simulations (FIG. 10).

It is believed that the differences between simulated and measured trends in FIG. 10 are caused by changes in the uncontrolled electromagnetic environment and unmodelled variations in the substrate permittivity with respect to the nominal value. All the simulated trends shown in FIG. 10 were found by relying on the pAG-technique to extract both the power threshold and the above-threshold response of varactors-based parametric frequency dividers. In this regard, it should be noted that both the measured and the simulated Pₜₕ values shown in FIG. 10 already take into consideration the relatively low gain achieved by the present ESA. Therefore, the present SubHT's intrinsic power threshold, which does not depend on the ESA's gain but only on the impedances seen by the varactor in the circuit, is believed to be even lower than the Pₜₕ values shown in FIG. 10.

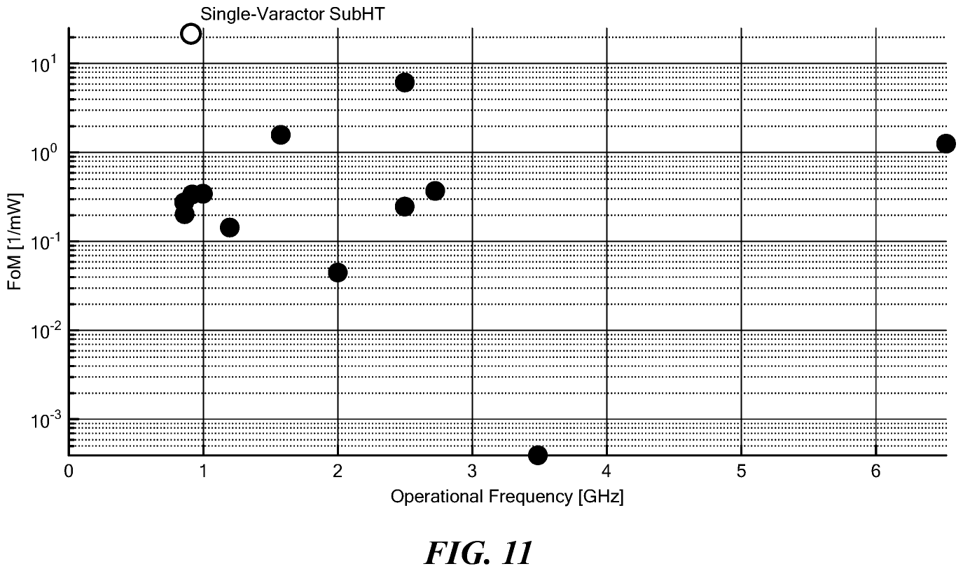

In order to benchmark the wireless performance of the present SubHT, it is useful to compare its highest measured dₘₐₓ value with the maximum reading range attained by existing passive tags. Yet for such a comparison to be meaningful, considering that many previous tags have been characterized by using several different EIRPs and frequencies for their interrogation signals, a generalized comparison criterion must be defined and used. Here, a figure-of-merit (FoM, see Eq. 1) was defined as the squared ratio of the maximum reading range to the maximum tag's dimension (D), normalized to the adopted EIRP in milliwatts. It is worth emphasizing that the square of the maximum dimension of any passive tag is proportional to its effective aperture and, consequently, to its antenna's gain at the adopted interrogation frequency. Using the FoM-expression in Eq. 1, the wireless performance attained by the present SubHT was compared with those achieved by existing passive tags (see FIG. 11).

$$F o M = {( \frac{{d}_{max}}{D} )}^{2} \cdot \frac{1}{EIRP} \qquad ( 1 )$$

As shown, the single-varactor SubHT exhibits the highest FoM value among all the existing passive tags identified by the inventors, exceeding their calculated FoM by three times or more.

Here, the wireless performance of the first single-antenna SubHT has been demonstrated. Despite its small size (area of 1.3 cm²), the SubHT of the present technology can achieve an exceptionally low Pₜₕ value of −8 dBm, enabling reading ranges exceeding 4.2 m. Owing to its single-antenna design and the subsequently high potential for miniaturization, this SubHT makes possible the development of highly distributed WSN networks for IoT applications demanding high spatial resolution.

### The Present Technology Includes at Least the Following Novel Features:

The SubHTs disclosed herein rely on a new circuit topology that has never been exploited before and that enables use of only one antenna for both the interrogation signal and the output signal.

The nonlinear dynamics of the disclosed subharmonic tags enable a superior degree of miniaturization because their RF sensitivity (and read range) improves as a high-quality factor (e.g., a smaller) antenna is used.

The adoption of an additional varactor in the two-varactor SubHT provides even further improvements the threshold and the read range, which can be up to −18 dBm and 13 meters, respectively. Considering the size of the tag, this is the most sensitive passive tag relying on electrically small antennas ever demonstrated.

### The Present Technology Offers at Least the Following Advantages:

The disclosed SubHTs enables use of only one antenna, reducing tremendously their occupied space and manufacturing cost.

The disclosed SubHTs allows higher degrees of miniaturization by leveraging unique dynamics that make its RF-sensitivity and read-range better when miniaturizing the antenna with respect to the conventional size used by passive tags.

The disclosed SubHTs can be miniaturized to a size that permits the adoption of subharmonic tags for IoT applications demanding high spatial resolutions.

### The Present Technology has at Least the Following Uses:

When coupled with a sensor, the tag will be usable to sense any parameter of interest.

Due to its small size and long-range, the tag can also be used for localization and ranging in GPS denied environments.

When built on a flexible substrate, the tag can be used to remotely monitor health signatures in patients.

Thus, described hereinabove are design, performance, and electrical characteristics of the first ever described single-antenna SubHTs. Owing to the nonlinear dynamics and despite an exceptionally small size, the single-antenna SubHTs described herein can achieve a Pth of −18 dBm, enabling reading ranges exceeding 13 m. The single-antenna design and resulting opportunity for miniaturization of SubHTs enable the development of distributed wireless sensor networks for Internet of Things and other applications that demand a fine-grained monitoring of targeted parameters of interest.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

What is claimed is:

1. A subharmonic tag comprising:
a single antenna having a reactive input impedance; and
a set of lumped components coupled to the antenna, the lumped components having a frequency-dependent input impedance, wherein the frequency-dependent input impedance of the lumped components causes the coupled antenna and lumped components to resonate at both an input frequency of the subharmonic tag and at an output frequency of the subharmonic tag.

2. The subharmonic tag of claim 1, wherein the single antenna is an electrically small antenna.

3. The subharmonic tag of claim 1, wherein the single antenna includes one or more of a resonant antenna, a dipole, a monopole, a loop, a short dipole, a small loop, a planar square loop, a microstrip, a dielectrically loaded patch, an aperture antenna, or combinations thereof.

4. The subharmonic tag of claim 1, wherein the subharmonic tag is formed on a substrate.

5. The subharmonic tag of claim 4, wherein the substrate is flexible.

6. The subharmonic tag of claim 4, wherein the substrate is a PCB.

7. The subharmonic tag of claim 1, wherein the subharmonic tag is formed in an integrated chip.

8. The subharmonic tag of claim 1, wherein the output frequency is half of the input frequency.

9. The subharmonic tag of claim 1, wherein the output frequency is 445 MHz and the input frequency is 890 MHz.

10. The subharmonic tag of claim 1, wherein the lumped components form a one-port parametric frequency divider (PFD).

11. The subharmonic tag of claim 10, wherein the lumped components forming the PFD further comprise:
a capacitive component;
an inductive component coupled in series to the capacitive component; and
an output component connected in parallel to an input component to form a frequency-dependent portion of the PFD, the frequency-dependent portion of the PFD coupled in series to the capacitive component and the inductive component.

12. The subharmonic tag of claim 11, wherein the capacitive component includes one or more of a capacitor or a varactor.

13. The subharmonic tag of claim 11, wherein the inductive component includes an inductor.

14. The subharmonic tag of claim 11, wherein each of the input component and the output component includes one or more of a capacitor, a varactor, an inductor, a MEMS resonator, a crystal resonator, a ceramic resonator, an inductive sensor, a capacitive sensor, or combinations thereof.

15. The subharmonic tag of claim 14, wherein the output component includes one or more of a capacitor or a varactor.

16. The subharmonic tag of claim 14, wherein the input component includes an inductor.

17. The subharmonic tag of claim 11, wherein the output component causes the coupled antenna and PFD to resonate at the output frequency of the subharmonic tag.

18. The subharmonic tag of claim 11, wherein the input component causes the coupled antenna and PFD to resonate at the input frequency of the subharmonic tag.

19. A method for passive wireless communication comprising:
providing a subharmonic tag comprising:
a single antenna having a reactive input impedance, and
a set of lumped components coupled to the antenna, the lumped components having a frequency-dependent input impedance, wherein the frequency-dependent input impedance of the lumped components causes the coupled antenna and lumped components to resonate at both an input frequency of the subharmonic tag and at an output frequency of the subharmonic tag.
receiving, by the antenna of the subharmonic tag, an interrogation signal having the input frequency;
resonating, responsive to the interrogation signal, the antenna and the lumped components at the output frequency; and
transmitting, responsive to the resonating of the antenna and the lumped components at the output frequency, an output signal from the antenna.

20. The method of claim 19, wherein the lumped components form a one-port parametric frequency divider (PFD), wherein the lumped components forming the PFD include a capacitive component, an inductive component coupled in series to the capacitive component, and an output component connected in parallel to an input component to form a frequency-dependent portion of the PFD, the frequency-dependent portion of the PFD coupled in series to the capacitive component and the inductive component.

21. The method of claim 20, wherein the output component causes the coupled antenna and PFD to resonate at the output frequency of the subharmonic tag.

22. The method of claim 20, wherein the input component causes the coupled antenna and PFD to resonate at the input frequency of the subharmonic tag.
